(19) United States
(12) Patent Application Publication
(10) Pub. No.: US 2012/0276445 A1
(43) Pub. Date: Nov. 1, 2012

(54) PURE FORMS OF LITHIUM BORATE SALTS AND THE PROCESS PRODUCING SUCH FORMS

(75) Inventor: Kang Conrad Xu, North Potomac, MD (US)

(73) Assignee: U.S. Government as represented by the Secretary of the Army, Adelphi, MD (US)

(21) Appl. No.: 13/253,996

(22) Filed: Oct. 6, 2011

Related U.S. Application Data
(60) Provisional application No. 61/407,153, filed on Oct. 27, 2010.

(51) Int. Cl. H01M 10/056; H01M 10/0525

(52) U.S. Cl. 429/199; 429/188; 429/246

(57) ABSTRACT

An electrolytic solution comprising a purified lithium borate salt that when used in lithium ion battery, delivers superior performances that include negligible irreversible capacity upon cell formation, low impedance on both cathode and anode, and excellent stability when operated at high temperatures.

### REFERENCE TO COPENDING AND ISSUED PATENTS

Attention is directed to commonly owned and assigned U.S. Pat. No. 7,824,802, issued Nov. 2, 2010, entitled “METHOD OF PREPARING A COMPOSITE CATHODE ACTIVE MATERIAL FOR RECHARGEABLE ELECTROCHEMICAL CELL, wherein there is disclosed a method of preparing a composite cathode active material having superior cell characteristics includes mixing and milling starting material, carbon and an organic complexing agent; U.S. Pat. No. 7,524,579 issued Apr. 28, 2009, entitled “NON-AQUEOUS SOLVENT ELECTROLYTE BATTERY WITH ADDITIVE ALKALI METAL SALT OF A MIXED ANHYDRIDE COMBINATION OF OXALIC ACID AND BORIC ACID, wherein there is disclosed a method for enhancing the performance characteristics of a battery through the use of the electrolyte composition comprised of a non-aqueous solvent, and a salt mixture; U.S. Pat. No. 7,442,471 issued Oct. 28, 2008, entitled “SOLVENT SYSTEMS COMPRISING A MIXTURE OF LACTAMS AND ESTERS FOR NON-AQUEOUS ELECTROLYTES AND NON-AQUEOUS ELECTROLYTE CELLS COMPRISING THE SAME; and U.S. Pat. No. 7,172,834 issued Feb. 6, 2007, entitled “ADDITIVE FOR ENHANCING THE PERFORMANCE OF ELECTROCHEMICAL CELLS.

The entire disclosures of each of the above mentioned patents are incorporated herein by reference in their entirety. The appropriate components and processes of these patents may be selected for the electrolyte and processes of the present invention in embodiments thereof.

### BACKGROUND

The present invention relates generally to lithium batteries. The embodiments herein relate to electrochemical battery systems with a high energy storage per unit weight. Applications include military equipment, weapon systems, and military communications. These systems require a battery to perform reliably under stringent environmental conditions. The lighter the battery, the less weight military personnel must carry. This need to supply portable electric power has brought about the development of lithium batteries that can provide the most energy for the least weight and volume. Two high energy density electrochemical candidates are the lithium-carbon monofluoride battery and the lithium-oxygen battery. The lithium-carbon monofluoride battery has a very high theoretical energy density of 3200 Wh/kg and excellent shelf life and storage characteristics. The lithium-oxygen battery has an even higher specific energy than the lithium-carbon mono-fluoride battery but because of poor storage and shelf-life characteristics from the migration of corrosive moisture and oxygen to the lithium anode, the lithium-oxygen battery still has not been developed for commercial application.

In embodiments the lithium ion battery comprises electrolytes that are based on a lithium salt dissolved in electrolyte solvents or more than one lithium salt dissolved in electrolyte solvents. During the operation of the lithium ion battery the dissolved and dissociated lithium salts should, in embodiments, not participate in any cell chemistry and remain inert to all other cell parts, except for providing conducting lithium ions to maintain the mass balance and electro-neutrality within the cell. However, this requirement can only be partially satisfied in the state-of-the-art lithium ion battery in a very narrow service temperature range of from about −20 degrees Celsius to about 50 degrees Celsius, because the lithium salt used almost exclusively in the lithium ion battery industry is based on a fluorinated phosphate anion, hexafluorophosphate (PF₆), which decomposes above sixty (60) degrees Celsius, and decomposes from the attack of the electrolyte solvents, producing a series of undesirable gaseous products and resulting in degraded battery performances such as rapid capacity fading, drastic rise in cell impedance, reduced power capability or even safety hazards.

Lithium-ion batteries utilize carbon anodes, lithiated transition metal oxide cathodes, and an organic-based solvent electrolyte with a dissolved conducting salt such as lithium hexafluorophosphate (LiPF₆). These batteries currently dominate the battery market in the area of cellular phones, cam-recorders, computers, and other electronic equipment. However, attempts to fully apply these battery technologies to military applications have met with disappointment.

In order to replace the thermally unstable LiPF₆, efforts were made to synthesize lithium salts based on a diversified spectrum of anions, the most promising of which arc based on borates. For example, LiBOB has been described as being able to support lithium ion chemistry with negligible loss in energy capacity at high temperatures up to about eighty (80) degrees Celsius, while lithium difluorooxalatoborate (LiDFOB) inherited most of LiBOB's merits with improved solubility in electrolyte solvents that are common for lithium ion battery industry. However, despite these results reported for laboratory test cells, the industry is having difficulties transferring these benefits to practical use, mainly because the bulk quantity of these salts are not available from commercial sources in purified asymmetric forms.

The common impurities in these lithium borate salts are oxalates or oxalate esters from unreacted starting materials, or various organic solvents from processes currently employed in commercial production of these lithium salts. As exemplified by the high field peak in the ¹¹B-NMR spectrum of impure LiBOB in the inset of FIG. 1, the impure forms of these lithium borate salts are characterized with a boron core that is not fully chelated by the ligands. The multiple signals in ¹H-NMR, which should not exhibit any proton signals in this case, indicates that solvents used in the process also remain and become part of the impurities. The corresponding ¹³C-NMR spectra are consistent with the structural identification showing multiple carbonyl or alkene signals in addition to the ligands of these borate anions.

Even though in trace amounts, impurities impose strongly unfavorable influence over the performance of salts when used in lithium ion batteries. Because their reduction potential is lower than those of the pure asymmetric form of lithium borate salts, they tend to decompose and deposit a thicker interphasial layer on electrodes and incur a higher irreversible capacity, as shown in FIG. 2 by the “shoulder” on charging curve corresponding to impure LiBOB. A direct consequence of this higher irreversible capacity is the lower battery capacity which results from the limited lithium ion being consumed during the process; more importantly, the interphasial layer thus formed is porous and cannot effectively protect the electrolyte components from continuing decomposition. Thus, with battery cycles and more electrolyte components decomposing, the porous interphase grows thicker, more lithium ions are consumed, and higher cell impedances occur. The above cycle is accelerated by elevated temperatures greater than about fifty (50) degrees Celsius, as FIG. 3 shows for electrolytes based on LiBOB salts that were purchased from commercial sources. Continuously consumed lithium ions and the corresponding increased impedance cause severe negative impacts on the performance of the lithium ion batteries that use impure lithium borate salts, as exemplified by the drastically decreasing power densities and the rapidly fading capacities of impure LiBOB in FIG. 4.

It is therefore of significant interest to the battery industry to have access to pure asymmetric forms of lithium borate salts, which include but are not limited to LiBOB and LiDFOB, and which are of satisfactory purity. With these purified asymmetric forms of lithium borate salts in lithium ion batteries, irreversible capacity of about less than eight percent is involved in the initial formation as exemplified by the curve corresponding to the pure form of LiBOB in FIG. 2, and the cell impedance does not increase with cycling as exemplified by the curve corresponding to the pure form of LiBOB in FIG. 3, and the capacity retention is stable with negligible fading, for example, less than about zero point one percent per cycle at elevated temperatures of greater than about fifty-five (55) degrees Celsius, as indicated by the curve corresponding to the pure form of Li BOB at 75 degrees Celsius in FIG. 4.

In embodiments, the present invention relates to a composition and process for producing purified asymmetric lithium salts and their application as electrolyte components of a lithium ion battery. The electrolyte component is typically a liquid, such as water or another solvent, with dissolved salts, acids, or alkalis to impart ionic conductivity. More particularly, this invention relates to the pure asymmetric form of lithium salts based on borate anion, and the unique solvent-based purification process and quality-control standards that produce the pure asymmetric form of lithium borates, for example, lithium difluorooxalatoborate (LiDFOB), lithium bis (oxalato) borate (LiBOB), and the like. Still more particularly, this invention relates to the pure form of lithium borate salts that support the operation of electrochemical devices, especially lithium ion batteries, as either a bulk electrolyte solute or as an additive.

Solvents may comprise, for example, N-methylpyrolidinone, N, N-dimethylacetamide, gamma-butyrolactone, methyl ethyl ketone, dimethoxyethane, tetrahydrofuran, dimethylformamide, ethylene carbonate, propylene carbonate, butylene carbonate, vinylene carbonate, dimethyl carbonate, diethyl carbonate, dipropyl carbonate, ethyl methyl carbonate, methylpropyl carbonate, ethylpropyl carbonate, methyl propionate, methyl butyrate, ethyl butyrate, and mixtures thereof.

When serving as either the bulk electrolyte solute or as an electrolyte additive in the non-aqueous electrolytes, the pure form of lithium borate salts impart far superior performances to lithium ion batteries in terms of very small irreversible capacity in the battery forming stage, for example, the irreversible capacity being less than ten (10) percent of the total reversible capacity. Other characteristics include the very conductive interphase layers corresponding to the charge-transfer component in the impedance spectra of less than 3.88×10⁴ ohm cm, and very low cell impedances. Tested cells for example, have been able to maintain ninety-five percent of their energy density after one thousand cycles, as well as stable capacity retention wherein from about 80 to about 90 percent of the battery capacity is maintained after about 200 cycles at elevated temperatures of, for example, greater than about 55 degrees Celsius, all of which the same lithium salts in impure forms that were produced from the prior art processes and available from commercial sources fail to deliver.

### SUMMARY

According to a first aspect of the present invention, there is provided an electrolytic solution comprising a nonaqueous electrolytic solvent. In another aspect, an electrolyte solution incorporating a purified lithium borate salt in concentrations of from about 0.01 M to about 2.0 M is provided. The purified lithium borate salt comprising a boron core coordinated by four (4) ligands; further comprising LiBOB, LiDFOB, LiBF₄, LiBMB or LiBPFPB, and mixtures thereof; wherein said purified lithium borate salt shows only one ¹¹B-signal and only one ¹³C-signal under the analysis of a Nuclear Magnetic Resonance Spectrophotometer; and wherein said purified lithium borate salt's solubility is greater than or equal to 0.5 M in nonaqueous electrolyte solvents and said purified lithium borate salt is capable of operating in a lithium ion battery at a temperature of from about fifty-five (55) to about eighty (80) degrees Celsius, said lithium ion battery cycle fading is less than zero point one (0.1) percent, with an irreversible capacity of less than eight (8) percent of a total capacity in a cell potential of from about 1.7 to about 2.0 volts, and both an AC and DC impedance during said lithium ion battery cycling at up to about eighty (80) degrees Celsius is less than about one (1) percent per cycle.

In further aspects, an embodiment herein provides an electrochemical cell comprising a negative electrode (cathode) comprising an electrode material that reversibly intercalates and de-intercalates any of cations and molecules; a positive electrode (anode) comprising an electrode active material that reversibly intercalates and de-intercalates any of cations, anions, and molecules; a separator material that separates the negative electrode from the positive electrode; and an electrolyte comprising a base electrolyte composition, ionic compound additive, and a solvent comprising any of aqueous and non-aqueous electrolyte solvents, wherein the additive comprises a solubility of at least about 0.01 in the base electrolyte composition, wherein the additive dissociates into corresponding cations and anions upon dissolution, and wherein the cations originate from a metal element and reduce to an elemental form at a potential that is at least about 0.5 Volts (V) above that of lithium.

### DESCRIPTION

### Definitions

Before describing the present invention in detail, it is to be understood that the terminology used herein is for the purposes of describing particular embodiments only, and is not intended to be limiting.

As referred to herein “anion” refers to a structure that bears negative formal charge.

As referred to herein “cation” refers to a structure that bears positive formal charge.

As referred to herein “ligand” refers to molecular compound that can coordinate with a central ion through its intrinsic or an induced dipole moment.

As referred to herein “purified asymmetric form of lithium bis(oxalate)borate (LiBOB) refers to lithium difluorooxalatoborate (LiDFOB).

As referred to herein “solvents” refers to molecular components of the electrolyte whose concentrations are greater than about 10 percent by weight.

As referred to herein “borate salts” refers to ionic compounds that contain a lithium cation and an anionic structure that is based on a boron core, which is tetrahedrally coordinated by four negative ligands. Examples may include, two bidentate ligands, or two monodentate ligands and one bidentate ligand, or the boron core may be coordinated by one tridentate ligand and one monodentate ligand.

As referred to herein “bulk salt” refers to the lithium salt being used in the electrolyte either the sole conducting salt, or as one of the conducting salt with molar percentage in the salt mixture greater than about 10 percent.

As referred to herein “additive” refers to electrolyte components, either solvent or salt, whose molar percentage is less than about 10 percent.

As referred to herein “molecular” refers to compounds that do not bear formal charges.

As referred to herein “non-aqueous” refers to molecular compounds that are not water-based.

As referred to herein “aprotic” refers to molecular compounds that do not dissociate in solution and generate protons, or molecular compounds that contain hydrogen that are easily reducible at above −2.0 V versus a Standard Hydrogen Electrode (SHE).

As referred to herein “chelation” refers to coordination of a central core ion by polydentate ligands.

In embodiments the borate anion of the lithium salts may comprise, for example, bis(oxalato)borate (BOB), difluorooxalato borate (DFOB), tetrafluoroborate (BF₄), bis(malonato)borate (BMB), bis(perfluoropinacolato)borate (BPFPB), and the like.

### BRIEF DESCRIPTION OF THE DRAWINGS

FIG. 1 shows the ¹¹B-(inset) and ¹H-NMR spectra of the impure form of LiBOB as commonly available from commercial sources or prepared by following the prior art processes.

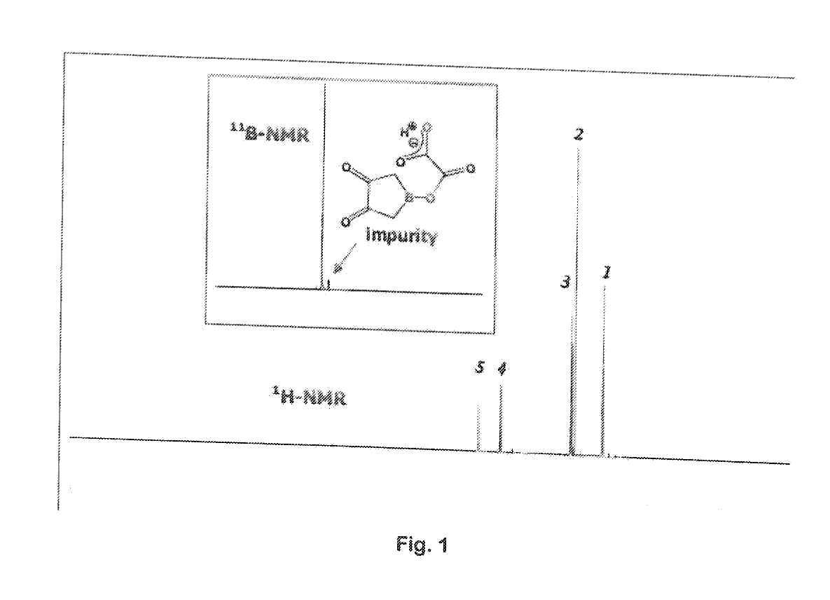

FIG. 2 shows the initial voltage profiles of the lithium ion batteries that employ the impure form of LiBOB, as prepared by following the prior art processes, and pure form of LiBOB according to the instant disclosure.

FIG. 3 shows the impedance increases during cycling of the lithium ion batteries that employ the impure form of LiBOB, as prepared by following the prior art process, and the pure form of LiBOB as produced by the process of this invention, respectively.

FIG. 4 shows the capacity retention at 75 degrees Celsius of the lithium ion batteries that employ the impure form of LiBOB, as prepared by prior art processes, and the pure form of LiBOB as produced by the process of this invention, respectively.

FIG. 5 shows the ¹¹B-(inset) and ¹H-NMR spectra of the pure form of LiBOB as produced by embodiments of the instant disclosure.

FIG. 6 shows the ¹³C-NMR spectra of a purified form of LiBOB as produced by embodiments of this disclosure, respectively.

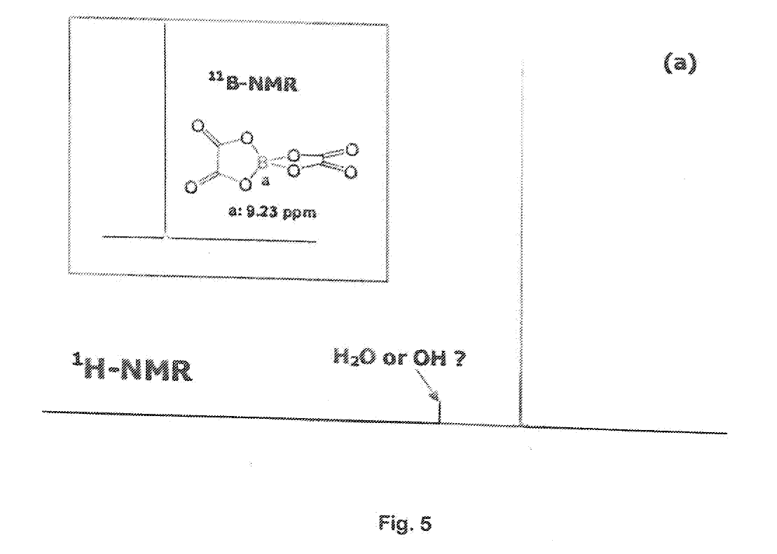

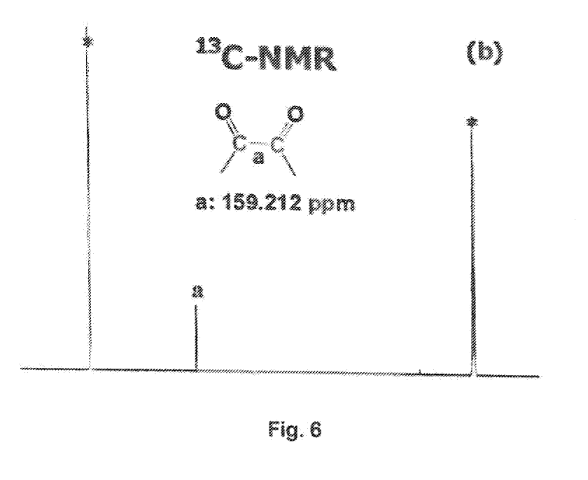

Pure asymmetric forms of lithium borate salts contain only a single signal in ¹¹B-NMR spectrum, do not show any substantial signals except trace amounts of moisture in the ¹H-NMR spectrum, and only show the carbon signals corresponding to the ligands that fully coordinate the boron core in ¹³C-NMR, as exemplified by the NMR spectra of pure form of LiBOB in FIGS. 5 and 6.

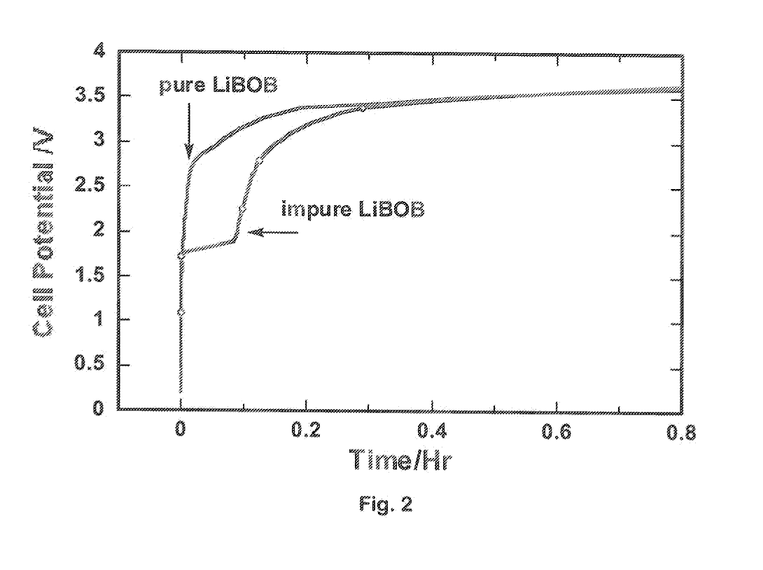

It is of more significant interest to the electrolyte suppliers in the lithium ion battery industry to find a reliable process that can produce purified forms of lithium borate salts, which comprise but are not limited to LiBOB, bis(oxalato)borate (BOB), difluorooxalato borate (DFOB), tetrafluoroborate (BF₄), bis(malonato)borate (BMB), and bis(perfluoropinacolato)borate (BPFPB), and which can deliver the desired performances as exemplified by the curves corresponding to the purified asymmetric form of LiBOB in FIGS. 2 through 4.

In embodiments, the present invention provides purified asymmetric forms of lithium borate salts. More specifically, this invention aims to eliminate the detrimental impurities that plague lithium borate salts used in electrochemical devices.

Therefore, it is highly desirable to provide pure forms of lithium borate salts that, when used in electrochemical devices, can deliver superior performances in terms of negligible cycle fading above fifty-five (55) degrees Celsius and stable battery capacity retention.

More specifically, it is highly desirable to provide pure forms of lithium borate salts comprising, bis(oxalato)borate (BOB), difluorooxalato borate (DFOB), tetrafluoroborate (BF₄), bis(malonato)borate (BMB), and bis(perfluoropinacolato)borate (BPFPB) and the like, which, when used in electrochemical devices, for example, lithium ion batteries, deliver desired characteristics as exemplified by the pure form of LiBOB in FIGS. 2 through 4.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Purified asymmetric lithium borate salts have been proposed for use in applications requiring superior performance in terms of negligible irreversible capacity upon cell formation, cell impedance of less than one percent per cycle at temperatures approaching eighty (80) degrees Celsius, and capacity fading of less than about 0.002 percent per cycle at temperatures approaching eighty (80) degrees Celsius.

In embodiments, the pure forms of lithium borate salts produced by the process disclosed herein deliver superior performances in electrochemical devices such as lithium ion batteries that impure forms of these same salts cannot. The purified forms of lithium borate salts produced by the process of the instant disclosure show a single ¹¹B-signal in NMR, and a negligible ¹H-signal, whose relative abundance compared with that of the 99.5 percent deuteriated solvent is less than 5 percent, as exemplified by the purified form of LiBOB in the inset of FIG. 5. Further, the purified forms of lithium borate salts produced only shows a single ¹³C-signal for carbonyl in NMR, as exemplified by the purified form of LiBOB in FIG. 6. When used in lithium ion batteries, the purified lithium borate salts generate less than 8 percent of irreversible capacity at potential interval between 1.5 and 2.0 volts (V) during the initial charging of the battery, as indicated in FIG. 2.

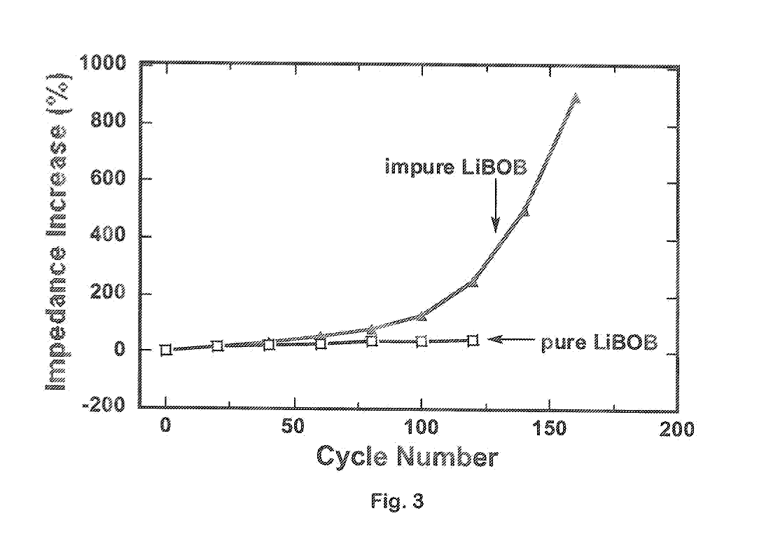

In addition, the purified forms of lithium borate salts produced, when used in lithium ion batteries, do not cause increases in cell impedance greater than 1 percent per cycle when the battery is cycled at elevated temperatures of about 80 degrees Celsius as illustrated in FIG. 3.

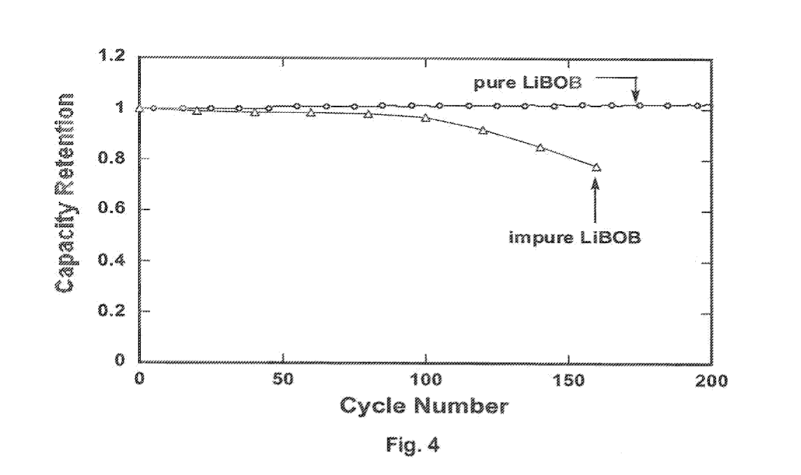

In yet another embodiment, the purified forms of lithium borate salts produced, when used in lithium ion batteries, do not cause a fading in capacity greater than about 0.002 percent per cycle when the battery is cycled at elevated temperatures up to about 80 degrees Celsius, as illustrated by the purified asymmetric form of LiBOB in FIG. 4.

In embodiments, the process that produces the purified forms of lithium borate salts comprise one or more steps of extraction with one solvent or mixtures of solvents. Dissolution and recrystallization of the lithium borate salts, additive, and/or bulk solutes may be repeated several times.

In another embodiment, the process that produces the above purified forms of lithium borate salts comprises extraction of the lithium borate salts with a dry solvent or mixtures of solvents at temperatures of less than about eighty (80) degrees Celsius, for example in a dry room, a glovebox, or a moisture-exclusion setup such as a manifold with drying tubes that one with ordinary skills in synthetic chemistry is familiar with. The extraction may be carried out using apparatus known in the art.

In embodiments, the extraction process is, for example, monitored by visual observation of the turbidity of the extraction solution. More specifically, but not intended to be limiting, the said extraction process is terminated at the point when the extraction solution becomes turbid due to the dissolution of excess amount of lithium borate salts.

In another aspect, the extraction process employs a dry solvent or solvent mixture as both extraction solvents and precipitation solvents, which are polar, non-aqueous, aprotic, and inert to the chelation bonds in the borate anions. The polar, non-aqueous, aprotic solvents may, for example, comprise the nitrile, sulfone, sulfoxide, sulfonate, ether and carboxylate ester families.

In addition, embodiments producing the pure asymmetric forms of lithium borate salts also comprise one or more steps of recrystallization of the said lithium borate salts in those solvent or mixtures of solvents.

In embodiments, the process that produces the above pure forms of lithium borate salts also comprise the drying of the lithium borate salts under vacuum at a temperature of up to about 120 degrees Celsius.

In yet other embodiments, the process that produces the above purified forms of lithium borate salts involve a solvent or mixture of solvents that serve as precipitation ingredients.

Further, the process that produces the above purified forms of lithium borate salts comprises a recrystallization, which is induced by either natural evaporation of solvents, the addition of crystal seedlings, or the addition of a precipitation solvent, or the combined techniques of all of the above.

The electrolyte solvents used in the process comprise mixtures of organic carbonates that may, for example, be cyclic in structure. For example, ethylene carbonate (EC) or propylene carbonate (PC) and mixtures thereof. The electrolyte solvents may also be linear in structure, for example, dimethyl carbonate (DMC), diethyl carbonate (DEC) or ethylmethyl carbonate (EMC), and mixtures thereof. Furthermore, these solvents may compromise non-carbonate molecular compounds, for example, gamma-butyronlactone (GBL), acetonitrile (AN), ethyl acetate (EA), methylbutyrate (MB) and mixtures thereof.

In other aspects, the electrolyte solutions of the present invention are formulated by incorporating the purified forms of lithium borate salts of this invention at various concentrations ranging from about 0.01 M to about 2.0 M.

Electrochemical devices where purified forms of lithium borate salts can be applied comprise (1) lithium ion cells with a graphitic carbon anode or a transition metal oxide anode and various transition metal oxide or olivine metalphosphates as the cathode; (2) electrochemical double layer capacitors with porous electrodes of either carbonaceous or other natures; (3) electrolytic cells; and (4) dual intercalation cells in which both cation and anion intercalate simultaneously into the lattices of the anode and cathode materials, respectively.

The above cells are assembled according to the procedures that can be readily performed by one of ordinary skill. These electrochemical devices containing the novel electrolyte solutions as disclosed in the instant application can afford improved rate capabilities and low temperature capacity utilizations.

### EXAMPLES

The following Examples are provided to illustrate certain aspects of the present disclosure and to aid those of skill in the art practicing the invention.

### Example 1

### Synthesis of LiBOB

Boric acid, oxalic acid and lithium hydroxide were dissolved in deionized water in molar ratios of 1:2:1. The solution was then distilled under normal pressure until a slurry was obtained. Continuous evaporation of water was carried out in a porcelain crucible, which was eventually placed in the oven at a temperature of about 180 degrees Celsius under vacuum. The obtained crude product is an impure form of LiBOB that contains a series of impurities including unreacted oxalate and borate that are only partially coordinated by ligands.

### Example 2

In another example, synthesis of LiBOB was conducted in non-aqueous media. Lithium tetra(methoxide)borate and di(methylsilyl)oxalate were mixed in dry acetonitrile at room temperature. After gentle heating to a temperature of about 50 degrees Celsius, the solvents are gradually removed by distillation under vacuum. An impure form of LiBOB was obtained by drying at a temperature of about 100 degrees Celsius under a vacuum.

### Example 3

The synthesis of LiBOB was conducted in non-aqueous Media by adding two equivalents of oxalic acid through a solid addition funnel to the suspension of lithium tetrahydroborate in dry tetrahydrofuran (THF). After the complete addition of oxalic acid, the mixture was heated to reflux of THF in order to accelerate the release of hydrogen gas. The solvent was removed under vacuum, and drying at a temperature of about 100 degrees Celsius under vacuum to gave an impure form of LiBOB.

### Example 4

In a further example, the synthesis can be conducted with the reactants in the solid state. Stoichiometric amounts of boric acid, oxalic acid and lithium hydroxide in a 1:1 molar ratio were grounded together and thoroughly mixed by ball-milling for an hour before being placed in a porcelain crucible in an oven at a temperature of about 180 degrees Celsius under vacuum. Crude product was obtained after heating up the crucible at a temperature of about 100 degrees Celsius under vacuum. The obtained crude product is an impure form of LiBOB.

### Example 5

### Purification of LiBOB

A pure form of LiBOB was obtained by a purification process starting with the impure forms of LiBOB as obtained in examples 1 through 4. A 1:1 (by volume) dry acetonitrile (AN) and toluene (TL) mixture was used to extract the crude product in a Soxhlet extractor. In other embodiments, a mixture of acetonitrile (AN) and tetrahydrofuran (THF) may alternatively be used as the extraction solvent, or, neat dry acetonitrile (AN) may be used as the extraction solvent. The extraction was terminated at the point when the solution in the bottom flask turned turbid. The solution was then left in a dry room fume hood at a dew point of about −80 degrees Celsius to about −90 degrees Celsius for the solvent to naturally evaporate. When the total volume of the solution was reduced to about two thirds of the original volume, white needle-like crystals precipitate. Further evaporation of solvents to no less than about one half ½ of the original volume. The crystals were collected-by filtration under dry atmosphere. After drying for about 16 hours under vacuum at about 110 degrees Celsius, the pure asymmetric form of LiBOB was obtained in about 50%, yield.

Alternatively, dimethyl carbonate (DMC), or ethyl acetate, or other linear carbonate or carboxylate ester solvents less than 10% of the original volume was used as a precipitation promoter. Thus, dry DMC was slowly added drop wise to the extraction solution with gentle stirring.

The resulting pure form of LiBOB was characterized by Thermogravametric Analysis (TGA), Infrared Analysis (IR) and Nuclear Magnetic Resonance (NMR). TGA analysis indicates that the pure form of LiBOB salt have a weight loss of less than 5 percent before reaching 200 degrees Celsius.

The NMR of the pure form of LiBOB showed only one single ¹¹B-signal, one single ¹³C-carbonyl signal, and only one negligible single peak in ¹H-NMR, the abundance of the latter is less than 2 percent of the deuteriated solvent used.

### Example 6

### Synthesis, Processing and Quality Control of Lithium Borate Salts

In a dry atmosphere with a dew point of from about −80 to about −90 degrees Celsius, lithium oxalate was suspended in a beaker with dried ethyl ether, to which boron trifluoride dithyl etherate were drop wise added at room temperature of from about 25 to about 27 degrees Celsius with vehement stirring. After the ethyl ether was evaporated, the suspension was dried in an oven at a temperature of from about 80 to about 100 degrees Celsius for about 2 hours to form a white solid mixture, which was further dried at a temperature of from about 100 to about 120 degrees Celsius under vacuum for about 6 hours followed by extraction using dry acetonitrile. The solvent in the resulting extraction was evaporated to form a crude product, which is the impure form of the salt.

The pure form of LiDFOB was obtained by recrystallization, during which a 1:1 (in volume) acetonitrile and toluene mixture was used to extract the crude product in a Soxhlet extractor. The extraction was terminated at the point when the solution in the bottom flask turned turbid. The solution was then left in a dry room fume hood for the solvent to naturally evaporate. When the total volume of the solution was reduced to approximately two thirds of the original volume, white needle-like crystals started to precipitate. Further evaporation of solvents lead to no less than one half of the original volume and the crystals were collected by filtration in dry room. After drying for 16 hours under vacuum at 110 degrees Celsius, about 70 percent pure form of the product LiDFOB was obtained. Alternatively, DMC, in an amount of less than 10 percent of the original volume can be used as precipitation promoter. Thus, dry DMC was slowly added drop wise to the extraction solution with gentle stirring.

The resulting pure form of LiDFOB was characterized by TGA, IR and NMR. TGA analysis indicates that the pure form of LiDFOB salts have a weight loss of less than 5 percent before reaching a temperature of about 150 degrees Celsius.

The nuclear magnetic resonance (NMR) spectra of the pure form of LiDFOB showed only one single ¹¹B-signal, one single carbonyl ¹³C-signal, and only one negligible single peak in ¹H-NMR, the abundance of the latter is less than 5% of the deuteriated solvent used.

### Example 8

### Preparation of the Electrolyte Solutions

This example summarizes a general procedure for the preparation of electrolyte solutions comprising purified forms of lithium borate salts, whose synthesis and processing have been disclosed in previous examples. Both the concentration of the lithium salts and the relative ratios between the solvents can be varied by those of ordinary skill in the art.

In embodiments, the resultant electrolyte solution may, for example comprise at least one of the following solvents: ethyl carbonate, propylene carbonate, dimethyl carbonate, diethyl carbonate, ethylmethyl carbonate, gamma-butyronlactone, acetonitrile, ethyl acetate, methylbutyrate and the like.

In other embodiments, the resultant electrolyte solution may comprise at least one of the following purified forms of lithium borate salts: LiBOB, LiDFOB, LiBF₄, LiBMB, LiBPFPB, and the like.

### Example 9

### Fabrication of a Lithium Ion Cell

A piece of Celgard polypropylene separator was sandwiched between an anode composite film based on graphitic carbon or a transition metal oxide such as spinel structured titanium oxide, and a cathode composite film that is based on either lithiated transition metal oxides, lithiated metalphosphate or mixtures thereof. The lithium ion cell was then activated by soaking the separator with the electrolyte solutions as prepared in Example 5, and sealed appropriately.

The disclosure above is for the purpose of illustration and not limitation. Those having skill in the arts relevant to the present invention will appreciate from the foregoing that the instant disclosure encompasses many additional embodiments that are not described explicitly, but which nevertheless are provided by the teachings of this application.

What is claimed is:

1. An electrolytic solution comprising:
(a) a nonaqueous electrolytic solvent;
(b) an electrolyte solution incorporating a purified lithium borate salt in concentrations of about 0.01 M to about 2.0 M;
(c) said purified lithium borate salt comprising a boron core coordinated by four (4) ligands;
(d) further comprising LiBOB, LiDFOB, LiBF₄, LiBMB, BOB, DFOB, BF₄, BMB, and BPFPB or LiBPFPB, and mixtures thereof;
(e) wherein said purified lithium borate salt shows only one ¹¹B-signal, only one ¹³C-signal, and only one carbonyl ¹³C-signal under the analysis of a Nuclear Magnetic Resonance Spectrophotometer;
(f) wherein said purified lithium borate salt's solubility is greater than or equal to 0.5 M in nonaqueous electrolyte solvents and said purified lithium borate salt is capable of operating in a lithium ion battery at a temperature of from about fifty-five (55) to about eighty (80) degrees Celsius;
(g) wherein said lithium ion battery cycle fading is less than zero point one (0.1) percent, with an irreversible capacity of less than eight (8) percent of a total capacity in a cell potential of from about 1.7 to about 2.0 volts, and both an AC and DC impedance during said lithium ion battery cycling at up to about eighty (80) degrees Celsius is less than about one (1) percent per cycle; and
(h) further wherein said electrolyte solution further comprises an ionic compound additive, wherein said additive dissociates into corresponding cations and anions upon dissolution, and wherein said cations originate from a metal element and reduce to an elemental form to a potential that is at least about 0.50 Volts above that of lithium, and wherein said anions remain stable at a surface of a negative electrode up to a potential of about 5.0 Volts above that of lithium, and said anions decompose and effectively passivate said surface of said negative electrode so that no sustaining decomposition occurs up to a potential of about 5.0 Volts above that of lithium.

2. An electrolytic solution according to claim 1, further comprising:
(a) a dissolution and recrystallization;
(b) wherein the dissolution and recrystallization are performed in an atmospheric dew point of about −90 degrees Celsius and at a temperature of from about 55 degrees Celsius to about 150 degrees Celsius, and
(c) further wherein the dissolution process comprises a polar solvent selected from the group consisting of a nitrile, a carbonate, a carboxylate ester, a sulfate ester, a sulfone, a sulfoxide, a sulfonate ester, an alkane, an alkene, an aromatic, an ether, and mixtures thereof, and
(d) still further wherein the dissolution process is conducted at a temperature of from about 80 to 150 degrees Celsius in an extractor having a filter or a thimble pore less than about 5 micrometers and wherein the filter or thimble is pre-dried under vacuum at temperatures greater than about 55 degrees Celsius.

3. An electrolytic solution according to claim 2:
(a) wherein the dissolution step occurs at a temperature of less than eighty (80) degrees Celsius,
(b) wherein a subsequent recrystallization occurs without heating and said recrystallization comprises the natural evaporation of the solvent, and
(c) further wherein the dissolution and recrystallization is repeated from one to three times.

4. An electrolytic solution according to claim 2:
(a) wherein the dissolution step occurs at a temperature of less than eighty (80) degrees Celsius;
(b) wherein a subsequent recrystallization occurs without heating;
(c) further wherein said recrystallization process comprises a polar precipitation solvent selected from the group consisting of a nitrile, a carbonate, a carboxylate ester, a sulfate ester, a sulfone, a sulfoxide, a sulfonate ester, an alkane, an alkene, an aromatic an ether, and mixtures thereof; and
(d) still further wherein the dissolution and recrystallization is repeated from one to three times.

5. A lithium ion battery for a nonaqueous electrolytic solution comprising:
(a) a polyolefin separator between an anode film comprising;
(b) a graphitic rechargeable battery capable of storing and discharging lithium ions, a transitional metal oxide and a cathode composite film comprised of lithiated transition metal oxide, lithiated metal phosphate and mixtures thereof.
(c) a purified asymmetric lithium borate salt additive, a bulk lithium salt,
(d) wherein said bulk lithium salt comprises lithium hexafluorophosphate (LiPF₆), lithium hexafluoroarsenate (LiAsF₆), lithium perfluoroalkylfluorophosphate LiP(CₙF₂ₙ₊₁)ₓF₆₋ₓ, where 0≦n≦10, 0≦x≦6), lithium perfluoroalkylfluoroborate (LiB(CₙF₂ₙ₊₁)ₓF₄₋ₓ, where 0≦n≦10, 0≦x≦4), lithium bis(trifluoromethanesulfonyl)imide (Lilm), lithium bis(perfluoroethanesulfonyl)imide (LiBeti), and mixtures thereof.
